(19) United States
(12) Patent Application Publication
(10) Pub. No.: US 2017/0197471 A1
(43) Pub. Date: Jul. 13, 2017

(54) PNEUMATIC TIRE

(71) Applicant: SUMITOMO RUBBER INDUSTRIES, LTD., Kobe-shi (JP)

(72) Inventor: Kimikazu TSUKAMOTO, Kobe-shi (JP)

(73) Assignee: SUMITOMO RUBBER INDUSTRIES, LTD., Kobe-shi (JP)

(21) Appl. No.: 15/384,529

(22) Filed: Dec. 20, 2016

(30) Foreign Application Priority Data
Jan. 8, 2016 (JP) 2016-002663

(51) Int. Cl. B60C 9/20; B60C 15/06

(52) U.S. Cl. CPC B60C 9/20; B60C 15/0635; B60C 2015/0639; B60C 2015/0642; B60C 2009/2067

(57) ABSTRACT

A pneumatic tire 2 includes a buttress reinforcing layer 22. A carcass 12 includes a first ply 38 and a second ply 40. The first ply 38 and the second ply 40 each have a main portion that is extended on and between beads 10 on both sides. The buttress reinforcing layer 22 extends along the first ply 38 and the second ply 40 between the first ply 38 and the second ply 40. An outer end 22a of the buttress reinforcing layer 22 is disposed inward of a shoulder region S of a tread 4 in a radial direction. An inner end 22b of the buttress reinforcing layer 22 is disposed at a maximum width position of the tire or disposed outward of the maximum width position of the tire in the radial direction.

This application claims priority on Patent Application No. 2016-002663 filed in JAPAN on Jan. 8, 2016. The entire contents of this Japanese Patent Application are hereby incorporated by reference.

### BACKGROUND OF THE INVENTION

Field of the Invention

The present invention relates to pneumatic tires.

Description of the Related Art

Reduction in weight of pneumatic tires is required in order to improve fuel efficiency of vehicles. From the viewpoint of the reduction in weight, reduction in volume of rubber of tires is considered. However, reduction in volume of rubber causes reduction in stiffness and durability of tires.

In JP2014-113957 (US2014/0158270), a tire that has a buttress reinforcing layer in a buttress portion is disclosed. The buttress reinforcing layer includes cords and topping rubber. The buttress reinforcing layer is disposed between a carcass and a belt layer. The buttress reinforcing layer contributes to increase of volume of rubber in the buttress portion. The buttress reinforcing layer contributes to improvement of stiffness of the tire. Further, the buttress reinforcing layer allows damage to a carcass cord to be reduced and contributes to improvement of durability of the tire.

The tire is obtained by vulcanizing an unvulcanized green tire. In the vulcanization, the green tire is heated and pressurized. In the vulcanization, the carcass of the green tire is drawn out, and a rubber material flows. In the vulcanization, the thickness of the rubber material around the carcass is likely to be also reduced. In particular, in the tire in which the thickness of the rubber material is reduced, the carcass is more likely to be drawn out, and the thickness of the rubber material is more likely to be reduced. Also in the tire having the buttress reinforcing layer, the volume of the rubber in the buttress portion is likely to be reduced in the vulcanization. Also in this tire, improvement of stiffness and durability, and increased reduction in weight are required.

An object of the present invention is to provide a tire that is excellent in stiffness and durability, and that can be reduced in weight.

### SUMMARY OF THE INVENTION

A pneumatic tire according to the present invention includes: a tread; a pair of sidewalls; a pair of beads; a carcass; and a buttress reinforcing layer. The sidewalls extend almost inward from ends, respectively, of the tread in a radial direction. The beads are disposed inward of the sidewalls, respectively, in the radial direction. The carcass is extended on and between one of the beads and the other of the beads, along inner sides of the tread and the sidewalls. The carcass includes a first ply and a second ply. The first ply and the second ply each have a main portion that is extended on and between the beads on both sides. The buttress reinforcing layer is formed of a rubber sheet. The buttress reinforcing layer extends along the first ply and the second ply between the first ply and the second ply. An outer end of the buttress reinforcing layer is disposed inward of a shoulder region of the tread in the radial direction. An inner end of the buttress reinforcing layer is disposed at a maximum width position of the tire or disposed outward of the maximum width position of the tire in the radial direction.

Preferably, the tire includes a bead reinforcing layer. The bead reinforcing layer extends outward from each bead in the radial direction. An outer end of the bead reinforcing layer is disposed at the maximum width position of the tire or disposed inward of the maximum width position of the tire in the radial direction.

Preferably, when Hb represents a height at the outer end of the bead reinforcing layer, and Hw represents a maximum width position height of the tire, the tire satisfies the following relational expression (1).

(Hb−Hw)≧−10 (mm) (1)

Preferably, the tire includes a belt that is layered over the carcass in a portion inward of the tread in the radial direction. The outer end of the buttress reinforcing layer is disposed inward of an outer end of the belt in an axial direction. A width Wa from the outer end of the buttress reinforcing layer to the outer end of the belt is greater than or equal to 10 (mm) and not greater than 20 (mm).

Preferably, when Hs represents a height at the inner end of the buttress reinforcing layer, and Hw represents a maximum width position height of the tire, the tire satisfies the following relational expression (2).

(Hs−Hw)≦15 (mm) (2)

Preferably, in the tire, a thickness T of the buttress reinforcing layer is greater than or equal to 0.8 (mm) and not greater than 1.2 (mm).

Preferably, the first ply and the second ply each include a carcass cord and topping rubber. The carcass cord is formed of a polyester fiber.

In the tire according to the present invention, the buttress reinforcing layer is disposed between the first ply and the second ply. Thus, the thickness of rubber of the buttress reinforcing layer is inhibited from being reduced during vulcanization. In the tire, even when the thickness and the weight of the rubber material are reduced, reduction of stiffness and durability can be inhibited.

### BRIEF DESCRIPTION OF THE DRAWINGS

FIG. 1 is a cross-sectional view of a part of a pneumatic tire according to one embodiment of the present invention.

### DESCRIPTION OF THE PREFERRED EMBODIMENTS

The following will describe in detail the present invention based on preferred embodiments with reference where appropriate to the accompanying drawing.

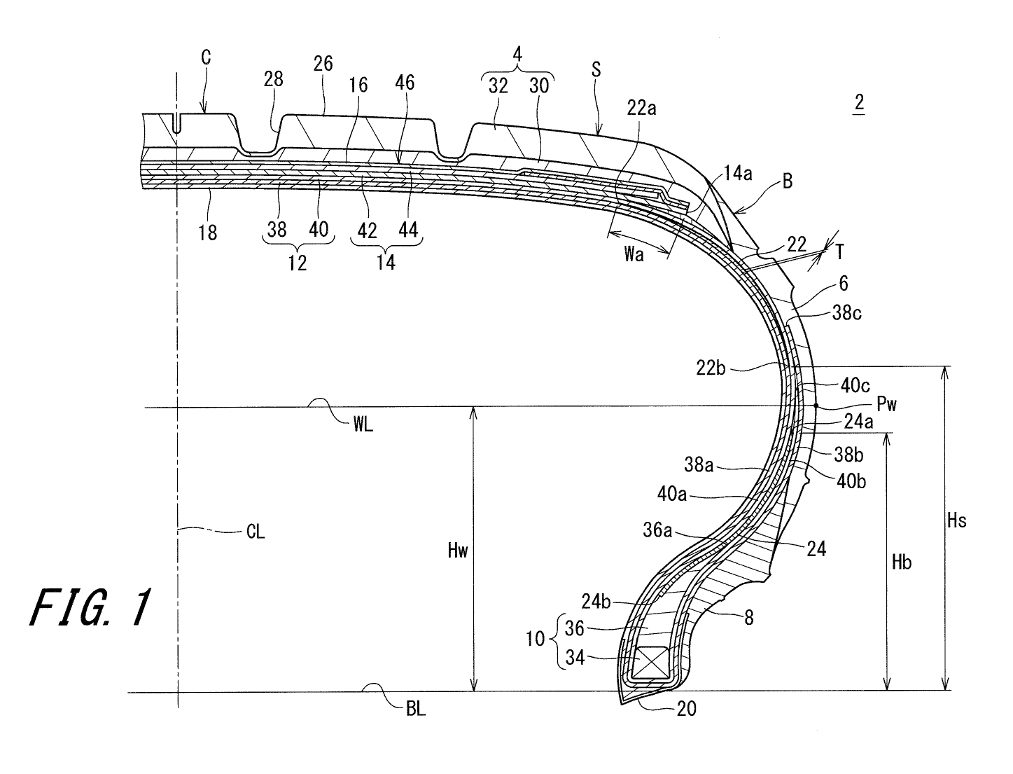

FIG. 1 shows a pneumatic tire 2. In FIG. 1, the up-down direction represents the radial direction of the tire 2, the left-right direction represents the axial direction of the tire 2, and the direction perpendicular to the surface of the drawing sheet represents the circumferential direction of the tire 2.

The tire 2 includes a tread 4, sidewalls 6, clinches 8, beads 10, a carcass 12, a belt 14, a band 16, an inner liner 18, chafers 20, buttress reinforcing layers 22, and bead reinforcing layers 24. The tire 2 is of a tubeless type. The tire 2 is mounted to, for example, an SUV (sport utility vehicle).

In FIG. 1, an alternate long and short dash line CL represents the equator plane of the tire 2. The shape of the tire 2 is symmetric about the equator plane except for a tread pattern. A solid line BL represents a bead base line. The bead base line represents a line that defines a rim diameter of a normal rim (see JATMA) on which the tire 2 is mounted. The bead base line extends in the axial direction. A solid line WL represents a straight line that extends through the maximum width points of the tire 2 in the axial direction. A point Pw represents a point, on the outer surface of the sidewall 6, which is at the outermost position in the axial direction. The straight line WL extends through the point Pw in the axial direction.

The tread 4 has a shape that projects outward in the radial direction. The tread 4 forms a tread surface 26 that can contact with a road surface. In the tread surface 26, grooves 28 are formed. A tread pattern is formed by the grooves 28. The tread 4 includes a base layer 30 and a cap layer 32. The cap layer 32 is disposed outward of the base layer 30 in the radial direction. The cap layer 32 is layered over the base layer 30. The base layer 30 is formed of crosslinked rubber excellent in adhesiveness. A typical base rubber of the base layer 30 is natural rubber. The cap layer 30 is formed of crosslinked rubber excellent in wear resistance, heat resistance, and grip performance. The tread 4 has a center region C disposed at the center in the axial direction, and a pair of shoulder regions S disposed outward of the center region C in the axial direction.

The sidewalls 6 extend almost inward from the ends of the tread 4 in the radial direction. The outer side ends, in the radial direction, of the sidewalls 6 are jointed to the shoulder regions S of the tread 4. The inner side ends, in the radial direction, of the sidewalls 6 are joined to the clinches 8. The sidewalls 6 are formed of crosslinked rubber excellent in cut resistance and weather resistance. The sidewalls 6 prevent damage to the carcass 12.

The clinches 8 are disposed almost inward of the sidewalls 6 in the radial direction. The clinches 8 are disposed outward of the beads 10 and the carcass 12 in the axial direction. The clinches 8 are formed of crosslinked rubber excellent in wear resistance. The clinches 8 contact with flanges of a rim.

The beads 10 are disposed inward of the clinches 8 in the axial direction. Each bead 10 includes a core 34 and an apex 36 that extends outward from the core 34 in the radial direction. The core 34 is ring-shaped, and includes a non-stretchable wound wire. The typical material of the wire is steel. The apex 36 is tapered toward an end 36a on the outer side in the radial direction. The apex 36 is formed of highly hard crosslinked rubber.

The carcass 12 includes a first ply 38 and a second ply 40. The first ply 38 and the second ply 40 are extended on and between the beads 10 on both sides, along the tread 4 and the sidewalls 6. The first ply 38 is turned up around the cores 34 from the inner side toward the outer side in the axial direction. By the turning-up, the first ply 38 includes a main portion 38a and turned-up portions 38b. The second ply 40 is turned up around the cores 34 from the inner side toward the outer side in the axial direction. By the turning-up, the second ply 40 includes a main portion 40a and turned-up portions 40b. The main portion 40a of the second ply 40 is layered outward of the main portion 38a of the first ply 38 in the radial direction. An end 38c of the turned-up portion 38b of the first ply 38 is disposed outward of an end 40c of the turned-up portion 40b of the second ply 40 in the radial direction. The turned-up portions 38b of the first ply 38 are layered over the main portion 40a of the second ply 40 in a portion outward of the ends 40c of the turned-up portions 40b of the second ply 40 in the radial direction.

The first ply 38 and the second ply 40 each include multiple carcass cords aligned with each other, and topping rubber. An absolute value of an angle of each carcass cord relative to the equator plane is from 75° to 90°. In other words, the carcass forms a radial structure. The carcass cords of the first ply 38 and the carcass cords of the second ply 40 intersect each other. The carcass cords are formed from an organic fiber. Preferable examples of the organic fiber include polyester fibers, nylon fibers, rayon fibers, polyethylene naphthalate fibers, and aramid fibers.

The belt 14 is layered outward of the carcass 12 in the radial direction. The belt 14 reinforces the carcass 12. The belt 14 is disposed inward of the tread 4 in the radial direction. The belt 14 includes an inner layer 42 and an outer layer 44. As is apparent from FIG. 1, in the axial direction, the width of the inner layer 42 is slightly greater than the width of the outer layer 44. The inner layer 42 and the outer layer 44 each include multiple cords aligned with each other, and topping rubber, which are not shown. Each cord is tilted relative to the equator plane. The absolute value of the tilt angle is greater than or equal to 10° and not greater than 35° in general. A direction in which the cords of the inner layer 42 tilt relative to the equator plane is opposite to a direction in which the cords of the outer layer 44 tilt relative to the equator plane. A preferable material of the cords is steel. An organic fiber may be used for the cords. The width of the belt 14 in the axial direction is preferably greater than or equal to 0.7 times the maximum width of the tire 2. The belt 14 may include three or more layers.

The band 16 is disposed outward of the belt 14 in the radial direction. In the axial direction, the width of the band 16 is greater than the width of the belt 14. The band 16 includes a cord and topping rubber, which are not shown. The cord is helically wound. The band 16 has a so-called jointless structure. The cord extends substantially in the circumferential direction. An angle of the cord relative to the circumferential direction is less than or equal to 5° and more preferably less than or equal to 2°. The belt 14 is held by the cord, and lifting of the belt 14 is thus inhibited. The cord is formed from an organic fiber. Preferable examples of the organic fiber include nylon fibers, polyester fibers, rayon fibers, polyethylene naphthalate fibers, and aramid fibers.

The belt 14 and the band 16 form a reinforcing layer 46. The reinforcing layer 46 may be formed merely by the belt 14.

The inner liner 18 is disposed inward of the carcass 12. Near the equator plane, the inner liner 18 is joined to the inner surface of the carcass 12. The inner liner 18 is formed of crosslinked rubber. For the inner liner 18, rubber excellent in airtightness is used. A typical base rubber of the inner liner 18 is isobutylene-isoprene-rubber or halogenated isobutylene-isoprene-rubber. The inner liner 18 maintains internal pressure of the tire 2.

The chafers 20 are disposed near the beads 10. When the tire 2 is mounted on a rim, the chafers 20 contact with the rim. By the contact, portions near the beads 10 are protected. The chafers 20 are formed of, for example, a fabric and rubber impregnated into the fabric. The chafers 20 and the clinches 8 may be integrated with each other. The material of the chafers 20 and the material of the clinches 8 may be the same crosslinked rubber.

The buttress reinforcing layers 22 are disposed along portions from the shoulder regions S of the tread 4 to the outer side portions, in the radial direction, of the sidewalls 6. The buttress reinforcing layers 22 are layered between the main portion 38a of the first ply 38 and the main portion 40a of the second ply 40. Outer ends 22a, in the radial direction, of the buttress reinforcing layers 22 are disposed inward of ends 14a of the belt 14 in the axial direction. Inner ends 22b, in the radial direction, of the buttress reinforcing layers 22 are disposed outward of the maximum width positions of the tire 2 in the radial direction. The inner ends 22b may be disposed at the maximum width positions of the tire 2. Each buttress reinforcing layer 22 is a rubber sheet formed of crosslinked rubber.

The bead reinforcing layers 24 each extend outward from the apex 36 in the radial direction. The bead reinforcing layers 24 are disposed between the main portion 40a and the turned-up portions 40b of the second ply 40 in the axial direction. In the tire 2, the bead reinforcing layers 24 are each disposed inward of the apex 36 in the axial direction. Outer ends 24a of the bead reinforcing layers 24 are disposed inward of the maximum width positions of the tire 2 in the radial direction. The outer ends 24a may be disposed at the maximum width positions of the tire 2. Inner ends 24b of the bead reinforcing layers 24 are each disposed inward of the end 36a of the apex 36 in the radial direction. Each bead reinforcing layer 24 is a rubber sheet formed of crosslinked rubber.

In FIG. 1, a double-headed arrow Hw represents a maximum width position height at the maximum width point of the tire 2. The maximum width position height Hw is measured as a distance, in the radial direction, from the bead base line to the maximum width position of the tire 2. A double-headed arrow Hb represents a height at the outer end 24a of the bead reinforcing layer 24. The height Hb is measured as a distance, in the radial direction, from the bead base line to the outer end 24a of the bead reinforcing layer 24. A double-headed arrow Hs represents a height at the inner end 22b of the buttress reinforcing layer 22. The height Hs is measured as a distance, in the radial direction, from the bead base line to the inner end 22b of the buttress reinforcing layer 22.

In FIG. 1, a double-headed arrow Wa represents a width from the outer end 22a of the buttress reinforcing layer 22 to the outer end 14a of the belt 14. The width Wa is measured along the outer surface of the buttress reinforcing layer 22. The width Wa is measured as a distance to the outer end 22a of the buttress reinforcing layer 22, from a point of intersection of: a straight line that extends through the outer end 14a of the belt 14 so as to be perpendicular to the outer surface of the buttress reinforcing layer 22; and the outer surface of the buttress reinforcing layer 22. A double-headed arrow T represents the thickness of the buttress reinforcing layer 22. The thickness T is measured, at the center position that is distant from the outer end 22a and is distant from the inner end 22b by the same distance, on the outer surface of the buttress reinforcing layer 22.

In the present invention, regions going from the shoulder regions S of the tread 4 into the sidewalls 6 are referred to as buttress portions B, respectively. Each buttress portion B is disposed in a portion where the tread 4 and the sidewall 6 are joined to each other. Therefore, during running, the buttress portion B is under a load from the sidewall 6. Stress is high in the buttress portion B. The tire 2 includes the buttress reinforcing layers 22. The buttress reinforcing layers 22 contribute to improvement of stiffness of the buttress portions B. The buttress reinforcing layers 22 reduce deformation of the buttress portions B during running. In the tire 2, heat generation during running is reduced.

In particular, in the tire 2 that has a reduced weight, the thickness of the rubber is reduced in regions going from the shoulder regions S of the tread 4 into the sidewalls 6. In the tire 2 that has a reduced weight, deformation is more likely to occur in the region going from the shoulder region S into the sidewall 6. In the region, the deformation is likely to occur particularly in the buttress portion B. The tire 2 includes the buttress reinforcing layers 22, whereby deformation in the buttress portions B is reduced in the tire 2.

Each buttress reinforcing layer 22 is a rubber sheet, and formed of crosslinked rubber. The buttress reinforcing layers 22 include no cords, so that increase in weight of the tire 2 is minimized. The buttress reinforcing layers 22 are appropriate to improve stiffness of the tire 2 having a reduced weight in particular.

The tire 2 is obtained by vulcanizing an unvulcanized green tire. The carcass 12 is drawn out by heating and pressurizing during the vulcanization. The buttress reinforcing layers 22 are disposed between the carcass cords of the first ply 38 and the carcass cords of the second ply 40 and the carcass cords of the first ply 38 and the carcass cords of the second ply 40 intersect each other. The buttress reinforcing layers 22, which are disposed between the carcass cords, are inhibited from flowing during the vulcanization. Although each buttress reinforcing layer 22 is a rubber sheet, each buttress reinforcing layer 22 is inhibited from flowing during vulcanization. The buttress reinforcing layers 22 inhibit the volume of rubber between the first ply 38 and the second ply 40 from being reduced. The buttress reinforcing layers 22 contribute to improvement of stiffness of the buttress portions B.

The buttress reinforcing layers 22 are inhibited from flowing during vulcanization, whereby dimensional management of the width Wa, the height Hs, and the thickness T is facilitated. The dimensional management is facilitated, whereby minimization of the volume of the rubber of the buttress portions B from the viewpoint of durability, is facilitated. In particular, in the region of the buttress portions B, deformation is likely to occur during running. Minimization of the volume of the rubber in the region greatly contributes to reduction of heat generation in the tire 2.

In order to obtain an effect of improving stiffness in the buttress portions B, the outer end 22a, of the buttress reinforcing layer 22, on the outer side in the radial direction, is disposed inward of the shoulder region S of the tread 4 in the radial direction. In order to obtain an effect of improving stiffness, the width Wa from the outer end 22a to the outer end 14a of the belt 14 is preferably greater than or equal to 10 (mm). Meanwhile, reduction of the width Wa contributes to reduction in weight of the tire 2. In this viewpoint, the width Wa is preferably not greater than 20 (mm).

The inner end 22b of the buttress reinforcing layer 22 is disposed at the maximum width position of the tire 2 or disposed outward of the maximum width position of the tire 2 in the radial direction. Thus, in a region going from the shoulder region of the tread 4 into the sidewall 6, an effect of improving stiffness is obtained. In order to obtain the effect of improving stiffness, a difference (Hs−Hw) between the height Hs up to the inner end 22b and the maximum width position height Hw of the tire 2 is preferably less than or equal to 15 (mm) and more preferably less than or equal to 10 (mm).

Meanwhile, when the height Hs is less than the maximum width position height Hw of the tire 2, a portion, at the maximum width position, of the tire 2 is reinforced by the buttress reinforcing layer 22. Enhancement of stiffness at the maximum width position of the tire 2 results in increase of deformation in the region going from the shoulder region S of the tread 4 into the sidewall 6. The increase of the deformation in this region causes increase of rolling resistance in the tire 2. In order to reduce rolling resistance, the height Hs is preferably greater than the height Hw.

In order to obtain an effect of improving stiffness, the thickness T of the buttress reinforcing layer 22 is preferably greater than or equal to 0.8 (mm) and more preferably greater than or equal to 0.9 (mm). Meanwhile, increase of the thickness T causes increase of rolling resistance. In order to reduce rolling resistance, the thickness of the buttress reinforcing layer 22 is preferably not greater than 1.2 (mm) and more preferably not greater than 1.1 (mm).

By the buttress reinforcing layers 22, reduction of the volume of the rubber between the first ply 38 and the second ply 40 is inhibited. Particularly in the region of the buttress portions, deformation is likely to occur during running. The buttress reinforcing layers 22 inhibit the carcass cords of the first ply 38 and the carcass cords of the second ply 40 from rubbing against each other due to deformation of the buttress portion B during running. The buttress reinforcing layers 22 contribute also to improvement of durability of the tire 2.

The tire 2 includes the bead reinforcing layers 24. The outer end 24a of the bead reinforcing layer 24 is disposed at the maximum width position of the tire 2 or disposed inward of the maximum width position of the tire 2 in the radial direction. When the bead reinforcing layers 24 are provided, stiffness of the sidewalls 6 in regions from the beads 10 to the outer ends 24a, in the radial direction, of the bead reinforcing layers 24, is improved. The bead reinforcing layers 24 contribute to improvement of stiffness of the tire 2. The bead reinforcing layers 24 contribute to improvement of lateral stiffness in particular.

The tire 2 includes the buttress reinforcing layers 22. Therefore, even when the bead reinforcing layers 24 are provided, increase of deformation in regions going from the shoulder regions S of the tread 4 into the sidewalls 6 is inhibited. When the tire 2 includes the buttress reinforcing layers 22 and the bead reinforcing layers 24, the tire 2 allows reduction in heat generation and is excellent also in lateral stiffness.

In order to improve stiffness, a difference (Hb−Hw) between the height Hb at the outer end 24a of the bead reinforcing layer 24 and the maximum width position height Hw of the tire 2, is preferably greater than or equal to −(mm) and more preferably greater than or equal to −5 (mm). Meanwhile, when the difference (Hb−Hw) is greater than 0, that is, when the outer end 24a of the bead reinforcing layer 24 is outward of the maximum width position of the tire 2, deformation in the region going from the shoulder region S of the tread 4 into the sidewall 6 is increased. Increase of the deformation in this region causes increase of rolling resistance of the tire 2. In order to reduce rolling resistance, the difference (Hb−Hw) is not greater than 0. The difference (Hb−Hw) is preferably not greater than −1 (mm).

In the tire 2, the carcass cords are formed of a polyester fiber. The carcass cords formed of a polyester fiber is more easily drawn out as compared to carcass cords formed of an aramid fiber. The carcass cords that are easily drawn out tend to cause reduction of the volume of rubber. Even when the carcass cords that are relatively easily drawn out are used, the buttress reinforcing layers 22 inhibit reduction of the volume of the rubber. The buttress reinforcing layers 22 are appropriate to the tire 2 that has the carcass cords formed of a polyester fiber. The buttress reinforcing layers 22 are appropriate also to a tire that has carcass cords formed of a nylon fiber, similarly to the tire that has the carcass cords formed of a polyester fiber.

In the present invention, the dimensions and angles of the components of the tire 2 are measured in a state where the tire 2 is mounted on a normal rim and inflated with air to a normal internal pressure. During the measurement, no load is applied to the tire 2. In the description herein, the normal rim represents a rim that is specified according to the standard with which the tire 2 complies. The “standard rim” in the JATMA standard, the “Design Rim” in the TRA standard, and the “Measuring Rim” in the ETRTO standard are normal rims. In the description herein, the normal internal pressure represents an internal pressure that is specified according to the standard with which the tire 2 complies. The “maximum air pressure” in the JATMA standard, the “maximum value” recited in “TIRE LOAD LIMITS AT VARIOUS COLD INFLATION PRESSURES” in the TRA standard, and the “INFLATION PRESSURE” in the ETRTO standard are normal internal pressures.

### EXAMPLES

Hereinafter, effects of the present invention will become apparent according to examples. However, the present invention should not be restrictively construed based on the description of examples.

### Example 1

A tire having the structure shown in FIG. 1 was prepared. The size of the tire was “P275/50R21 113V PT3A”. The “thickness of buttress portion” is indicated below in Table 1 and Table 2 as an index with the rubber volume of the buttress portion of the tire of comparative example 1 being 100 as a reference value. The less the index is, the less the rubber volumes is.

### Comparative Example 1

A tire having the same structure as in example 1 except that no buttress reinforcing layers were provided and the rubber volume of the buttress portion was 100 as the reference value, was prepared. This tire was a commercially available tire.

### Comparative Example 2

A tire having the same structure as in example 1 except that no buttress reinforcing layers were provided, was prepared. This tire was also a commercially available tire.

### Examples 2 to 3

Tires each having the same structure as in example 1 except that the difference (Hs−Hw) was different as indicated in Table 1, were prepared.

### Examples 4 to 7

Tires each having the same structure as in example 1 except that the difference (Hb−Hw) and the difference (Hs−Hw) were different as indicated in Table 2, were prepared.

### Example 8 and Comparative Example 3

Tires each having the same structure as in example 1 except that the difference (Hb−Hw) was different as indicated in Table 2, were prepared.

[Weight]

A weight of each tire was measured. The weight is indicated below in Table 1 and Table 2 as an index with the weight of comparative example 1 being 100 as a reference value. The less the value of the index is, the less the weight is and the better the evaluation is.

[Rolling Resistance Coefficient]

Each tire was mounted on a normal rim of “21×8.5J”. For each tire, a rolling resistance testing machine was used to measure a rolling resistance coefficient (RRC) under the following measurement conditions. The results thereof are indicated below in Table 1 and Table 2 as indexes with the result of comparative example 1 being 100 as a reference value. The less the value of the index is, the less rolling resistance is and the better the evaluation is.

Internal pressure: 230 (kPa)

Load: 4.41 (kN)

Speed: 80 (km/h)

[Lateral Stiffness]

Each tire was mounted on a normal rim, and a tire static tester was used to measure a lateral stiffness constant under the following measurement conditions. The results are indicated below in Table 1 and Table 2 as indexes with the result of comparative example 1 being 100 as a reference value. The greater the value of the index is, the higher lateral stiffness is and the better the evaluation is.

Internal pressure: 230 (kPa)

Load: 5.30 (kN)

[Cornering Power]

Each tire was mounted on a normal rim, and a flat belt type test machine was used to measure cornering power under the following measurement conditions. The results are indicated below in Table 1 and Table 2 as indexes with the result of comparative example 1 being 100 as a reference value. The greater the value of the index is, the higher cornering power is and the better the evaluation is.

Internal pressure: 230 (kPa)

Load: 5.30 (kN)

Speed: 20 (km/h)

[Steering Stability]

Each tire was mounted on a normal rim, and inflated with air to an internal pressure of 230 (kPa). The tires were mounted to a four-wheel-drive SUV having an engine displacement of 4600 (cc) (4600 (cm³)). A driver was caused to drive the SUV on a test course, and evaluate steering stability. The results are indicated below in Table 1 and Table 2 as indexes with the result of comparative example 1 being 100 as a reference value. The greater the value of the index is, the better the evaluation is.

TABLE 1
Evaluation result

| | Comp. | Comp. | | | |
|---|---|---|---|---|---|
| | ex. 1 | ex. 2 | Ex. 1 | Ex. 2 | Ex. 3 |
| Thickness of | 100 | 80 | 80 | 80 | 80 |
| buttress portion | | | | | |
| (Hb − Hw) (mm) | 0 | 0 | −5 | −5 | −5 |
| Buttress | Not | Not | Pro- | Pro- | Pro- |
| reinforcing layer | provided | provided | vided | vided | vided |
| (Hs − Hw) (mm) | — | — | 10 | −5 | +20 |
| Width Wa (mm) | — | — | 15 | 15 | 15 |
| Weight | 100 | 80 | 80 | 85 | 80 |
| Rolling resistance | 100 | 80 | 80 | 85 | 80 |
| Lateral stiffness | 100 | 80 | 110 | 100 | 105 |
| Cornering power | 100 | 80 | 110 | 100 | 105 |
| Steering stability | 100 | 80 | 110 | 100 | 105 |

TABLE 2
Evaluation result

| | | | | | | Comp. |
|---|---|---|---|---|---|---|
| | Ex. 4 | Ex. 5 | Ex. 6 | Ex. 7 | Ex. 8 | ex. 3 |
| Thickness of | 80 | 80 | 80 | 80 | 80 | 80 |
| buttress | | | | | | |
| portion | | | | | | |
| (Hb-Hw) (mm) | −10 | 0 | −10 | 0 | −15 | 5 |
| Buttress | Provided | Provided | Provided | Provided | Provided | Provided |
| reinforcing | | | | | | |
| layer | | | | | | |
| (Hs-Hw) (mm) | 0 | 0 | 15 | 15 | 10 | 10 |
| Width Wa (mm) | 15 | 15 | 15 | 15 | 15 | 15 |
| Weight | 82 | 85 | 78 | 82 | 80 | 85 |
| Rolling | 87 | 90 | 78 | 87 | 80 | 95 |
| resistance | | | | | | |
| Lateral | 100 | 110 | 105 | 100 | 90 | 110 |
| stiffness | | | | | | |
| Cornering power | 100 | 110 | 105 | 100 | 90 | 110 |
| Steering | 100 | 110 | 105 | 100 | 90 | 110 |
| stability | | | | | | |

As indicated in Tables 1 and 2, evaluation is higher in the tires of examples than in the tires of comparative examples. The evaluation result clearly indicates that the present invention is superior.

The tire described above can be mounted to not only SUVs but also various vehicles such as passenger cars, lightweight trucks, light trucks, trucks, and buses.

The foregoing description is in all aspects illustrative, and various modifications can be devised without departing from the essential features of the invention.

What is claimed is:

1. A pneumatic tire comprising:
a tread;
a pair of sidewalls;
a pair of beads;
a carcass; and
a buttress reinforcing layer, wherein
the sidewalls extend almost inward from ends, respectively, of the tread in a radial direction,
the beads are disposed inward of the sidewalls, respectively, in the radial direction,
the carcass is extended on and between one of the beads and the other of the beads, along inner sides of the tread and the sidewalls,
the carcass includes a first ply and a second ply,
the first ply and the second ply each have a main portion that is extended on and between the beads on both sides,
the buttress reinforcing layer is formed of a rubber sheet,
the buttress reinforcing layer extends along the first ply and the second ply between the first ply and the second ply,
an outer end of the buttress reinforcing layer is disposed inward of a shoulder region of the tread in the radial direction, and
an inner end of the buttress reinforcing layer is disposed at a maximum width position of the tire or disposed outward of the maximum width position of the tire in the radial direction.

2. The tire according to claim 1, comprising a bead reinforcing layer, wherein
the bead reinforcing layer extends outward from each bead in the radial direction, and
an outer end of the bead reinforcing layer is disposed at the maximum width position of the tire or disposed inward of the maximum width position of the tire in the radial direction.

3. The tire according to claim 2, wherein
when Hb represents a height at the outer end of the bead reinforcing layer, and Hw represents a maximum width position height of the tire,
the following relational expression (1) is satisfied.
(Hb−Hw)≧−10 (mm) (1)

4. The tire according to claim 1, comprising a belt that is layered over the carcass in a portion inward of the tread in the radial direction,
the outer end of the buttress reinforcing layer is disposed inward of an outer end of the belt in an axial direction, and
a width Wa from the outer end of the buttress reinforcing layer to the outer end of the belt is greater than or equal to 10 (mm) and not greater than 20 (mm).

5. The tire according to claim 1, wherein
when Hs represents a height at the inner end of the buttress reinforcing layer, and Hw represents a maximum width position height of the tire,
the following relational expression (2) is satisfied.
(Hs−Hw)≦15 (mm) (2)

6. The tire according to claim 1, wherein a thickness of the buttress reinforcing layer is greater than or equal to 0.8 (mm) and not greater than 1.2 (mm).

7. The tire according to claim 1, wherein
the first ply and the second ply each include a carcass cord and topping rubber, and
the carcass cord is formed of a polyester fiber.
